(19) United States
(12) Patent Application Publication
(10) Pub. No.: US 2016/0041443 A1
(43) Pub. Date: Feb. 11, 2016

(54) CURVED LIQUID CRYSTAL PANEL

(71) Applicant: Shenzhen China Star Optoelectronics Technology Co. Ltd., Shenzhen, Guangdong (CN)

(72) Inventor: Chuan WU, Shenzhen, Guangdong (CN)

(73) Assignee: Shenzhen China Star Optoelectronics Technology Co. Ltd., Shenzhen, Guangdong (CN)

(21) Appl. No.: 14/390,762

(22) PCT Filed: Aug. 21, 2014
(86) PCT No.: PCT/CN2014/084872

§ 371 Date: Oct. 3, 2014

(30) Foreign Application Priority Data
Aug. 8, 2014 (CN) 201410391239.6

(51) Int. Cl. G02F 1/1362; G02F 1/1335; G02F 1/1368

(52) U.S. Cl. CPC G02F 1/136286; G02F 1/1368; G02F 1/133514; G02F 1/133512

(57) ABSTRACT

The present invention provides a curved liquid crystal panel, comprising a TFT substrate (1), a CF substrate (3) oppositely positioned to the TFT substrate (1) and a liquid crystal layer (5) located between the TFT substrate (1) and the CF substrate (3), and the TFT substrate (1) comprises a plurality of data lines (11), and the plurality of data lines (11) is equidistantly aligned, and the CF substrate (3) comprises an arrayed black matrix (31), in flat state, a gap L1 between two adjacent data lines (11) and a gap L2 of the black matrix (31) in an aligned direction of data lines (11) are unequal, and a proportional relation exists between the L1 and the L2; in curved state, the black matrix (31) radially coincides all data lines (11) along a curved direction to make the pixel areas of the TFT substrate (1) and the CF substrate (3) matched. The curved liquid crystal panel is capable of preventing defects of light leakage, crosstalk and etc. to promote display and optical qualities of the curved liquid crystal panel.

### FIELD OF THE INVENTION

The present invention relates to a display skill field, and more particularly to a curved liquid crystal panel.

### BACKGROUND OF THE INVENTION

A Liquid Crystal Display (LCD) possesses advantages of being ultra thin, power saved and radiation free. It has been widely utilized in, such as LCD TVs, mobile phones, PDAs (personal digital assistance), digital cameras, laptop screens or notebook screens.

Generally, a liquid crystal display comprises a shell, a liquid crystal panel located in the shell and a backlight module located in the shell. The liquid crystal panel mainly comprises a Thin Film Transistor Array Substrate (TFT Array Substrate), a Color Filter (CF) substrate and a Liquid Crystal Layer located between the two substrates. The working principle is that the light of backlight module is reflected to generate images by applying driving voltages to the two glass substrate for controlling the rotations of the liquid crystal molecules.

In recent years, with the development of the liquid display technology, many major vendors are progressively selling curved liquid crystal displays. Generally speaking, the curved liquid crystal display can provide the best view effect from the center to the edges. A normal liquid crystal display still fails to provide ideal display ability at the edges of the screen. With the curved appearance design of the entire screen, the curved liquid crystal display is capable of providing a wide panoramic view image effect. Either at the center or the peripheral edges of the screen, the view pleasure can be the same. Meanwhile, the distortion of the off axis view in a close range can be eliminated. Furthermore, the curved liquid crystal display allows a longer watch distance for the audiences to provide a better view experience. Therefore, compared with the normal liquid crystal display, the curved liquid crystal display has enormous advantages: 1, product differentiation; 2, wider view angle; 3, eliminated distortion of the close range view.

The curved liquid crystal panel is the core component of the curved liquid crystal display. The manufacture procedure of the present curved liquid crystal panel is: first, the manufacture of the liquid crystal panel in fat state is accomplished, and then the liquid crystal panel in fat state is bended to form a curved liquid crystal panel. As shown in FIG. 1, a curved liquid crystal panel according to prior art is in flat state. A gap between two adjacent data lines 101 of the TFT substrate 100 and a gap of the black matrix 301 in an aligned direction of data lines 101 are equal, and indicated as L. In another word, the black matrix 301 corresponds to all the data lines 101. However, when the liquid crystal panel is bended and in curved state, as shown in FIG. 2, the curved liquid crystal panel possesses a certain radian. Relative slides will occur between the bended CF substrate 300 and the TFT substrate 100. Under circumstance that the center of the CF substrate 300 is the reference point, the left side of the CF substrate will slide toward the left relative to the TFT substrate 100 and the right side of the CF substrate will slide toward the right relative to the TFT substrate 100. Thus, the black matrix 301 will no longer correspond to the data lines 101 but misalignment appears relative to the radial direction of the curved liquid crystal panel. Consequently, it leads to that the pixel areas of the TFT substrate 100 and the CF substrate are not matched. The defects of light leakage, crosstalk and etc. happen to cause the display image distortion of the curved liquid crystal panel and reduction of the optical quality.

### SUMMARY OF THE INVENTION

An objective of the present invention is to provide a curved liquid crystal panel capable of preventing defects of light leakage, crosstalk and etc. to promote display and optical qualities of the curved liquid crystal panel.

For realizing the aforesaid objective, the present invention provides a curved liquid crystal panel, comprising a TFT substrate, a CF substrate oppositely positioned to the TFT substrate and a liquid crystal layer located between the TFT substrate and the CF substrate, and the TFT substrate comprises a plurality of data lines, and the plurality of data lines is equidistantly aligned, and the CF substrate comprises an arrayed black matrix, and a predetermined bending radius R of the CF substrate is, and a cell thickness of the liquid crystal layer is d, in flat state, a gap L1 between two adjacent data lines and a gap L2 of the black matrix in an aligned direction of data lines are unequal, and a proportional relation exists between the L1 and the L2; in curved state, the black matrix radially coincides all data lines along a curved direction to make the pixel areas of the TFT substrate and the CF substrate matched.

The predetermined bending radius R of the CF substrate is a distance from a center of the CF substrate in curved state to a surface of the CF substrate close to the liquid crystal layer.

The curved liquid crystal panel is bended toward the CF substrate.

The proportional relation of the L1 and the L2 is L1:L2=(R+d):R.

The curved liquid crystal panel is bended toward the TFT substrate.

The proportional relation of the L1 and the L2 is L1:L2=(R−d):R.

In curved state, the pixel areas of the TFT substrate and the CF substrate are matched and open area and shielding area of the curved liquid crystal panel are perpendicularly opposite.

The shielding area comprises the black matrix on the CF substrate and wiring location of the data lines on the TFT substrate.

The benefits of the present invention are: according to the curved liquid crystal panel of the present invention, the gap L1 between two adjacent data lines and the gap L2 of the black matrix in an aligned direction of data lines are set to have the proportional relation in flat state to prevent misalignment of the black matrix and the data lines in curved state. Accordingly, the defects of light leakage, crosstalk and etc. can be prevented to promote display and optical qualities of the curved liquid crystal panel.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution, as well as beneficial advantages, of the present invention will be apparent from the following detailed description of an embodiment of the present invention, with reference to the attached drawings.

In drawings,

FIG. 1 is a diagram of a curved liquid crystal panel in flat state according to prior art;

FIG. 2 is a diagram of a curved liquid crystal panel in curved state according to prior art;

FIG. 3 is a diagram showing a first embodiment of a curved liquid crystal panel in flat state according to the present invention;

FIG. 4 is a diagram showing a first embodiment of a curved liquid crystal panel in curved state according to the present invention;

FIG. 5 is a diagram showing a second embodiment of a curved liquid crystal panel in flat state according to the present invention;

FIG. 6 is a diagram showing a second embodiment of a curved liquid crystal panel in curved state according to the present invention.

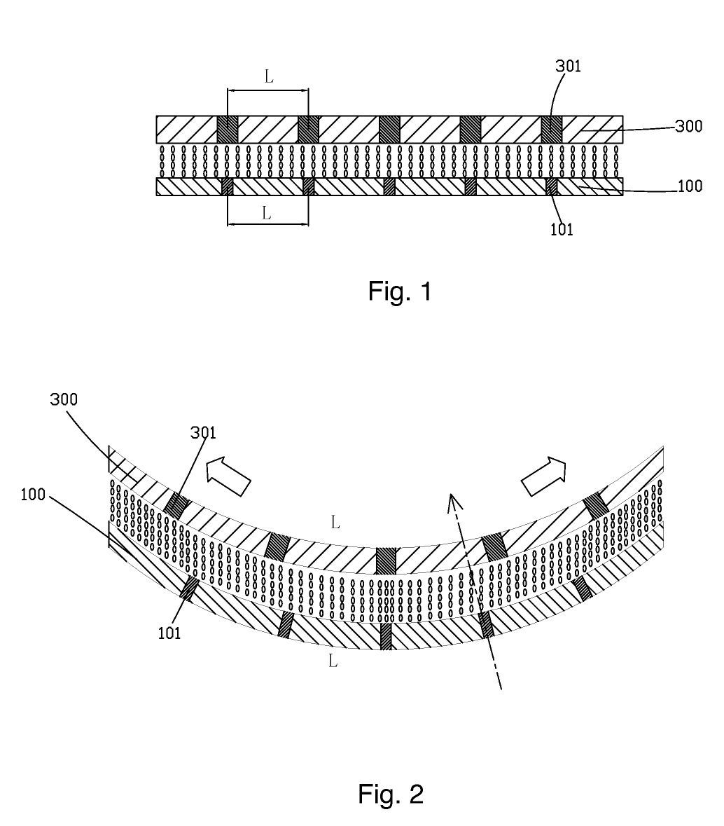

### DETAILED DESCRIPTION OF PREFERRED EMBODIMENTS

Embodiments of the present invention are described in detail with the technical matters, structural features, achieved objects, and effects with reference to the accompanying drawings as follows.

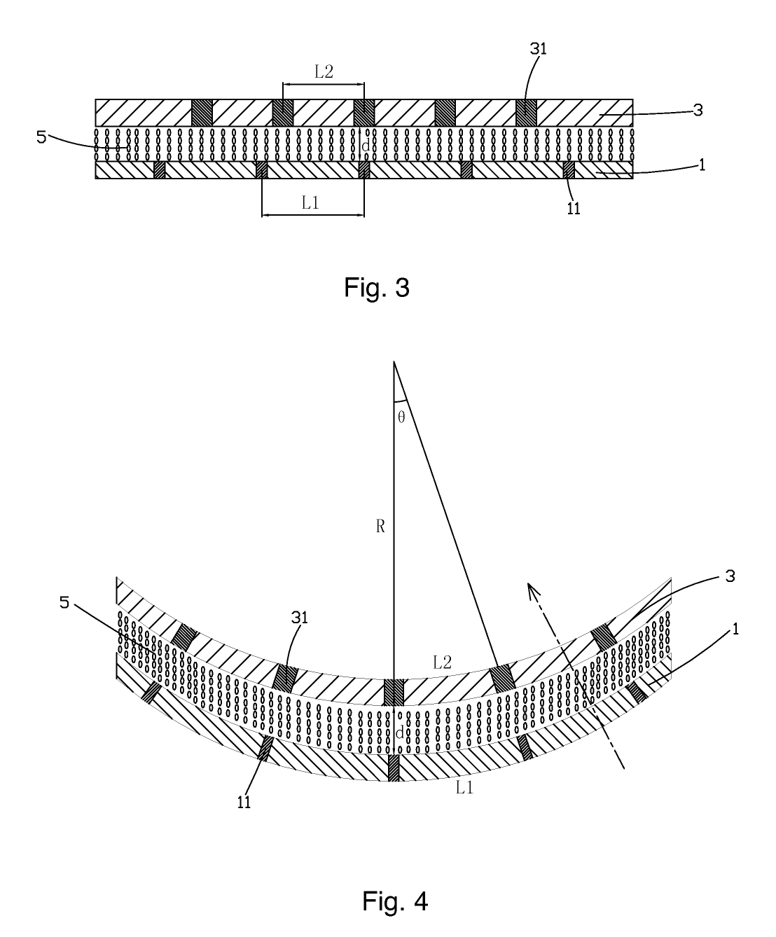

Please refer from FIG. 3 to FIG. 4, which show a first embodiment of a curved liquid crystal panel in curved state according to the present invention. The curved liquid crystal panel comprises a TFT substrate 1, a CF substrate 3 oppositely positioned to the TFT substrate 1 and a liquid crystal layer 5 located between the TFT substrate 1 and the CF substrate 3.

The TFT substrate 1 comprises a plurality of data lines 11, and the plurality of data lines 11 is equidistantly aligned. The CF substrate 3 comprises an arrayed black matrix 31.

A predetermined bending radius of the CF substrate 3 is R, and a cell thickness of the liquid crystal layer 5 is d. Specifically, the predetermined bending radius R of the CF substrate 3 is a distance from a center of the CF substrate 3 in curved state to a surface of the CF substrate 3 close to the liquid crystal layer 5.

For allowing the black matrix 31 shielding all data lines 11 when the curved liquid crystal panel is in curved state, the black matrix 31 are set to radially coincide all data lines 11 along a curved direction to make the pixel areas of the TFT substrate 1 and the CF substrate 3 matched and prevent defects of light leakage, crosstalk and etc.

In the first embodiment, the curved liquid crystal panel is an internally bended type, in which the curved liquid crystal panel bended toward the CF substrate 3.

For realizing that the black matrix 31 radially coincides all data lines 11 along the curved direction, an arc length L1 between two adjacent data lines 11, i.e. the gap L1 between two adjacent data lines in flat state and the gap L2 of the black matrix 31 corresponding to the curved direction, i.e. the gap L2 of the black matrix 31 in the aligned direction of data lines 11 in flat state are required to satisfy the following conditions:

L1=θ×(R+d) (1)

L2=θ×R (2)

wherein θ is a radian corresponding to L1 and L2.

with combination of formula (1), formula (2), which can be derived:

L1=L2=(R+d):R (3)

Accordingly, the gap L1 between two adjacent data lines 11 and the gap L2 of the black matrix 31 in the aligned direction of data lines 11 are unequal, and a proportional relation exists between the L1 and the L2:L1:L2=(R+d):R.

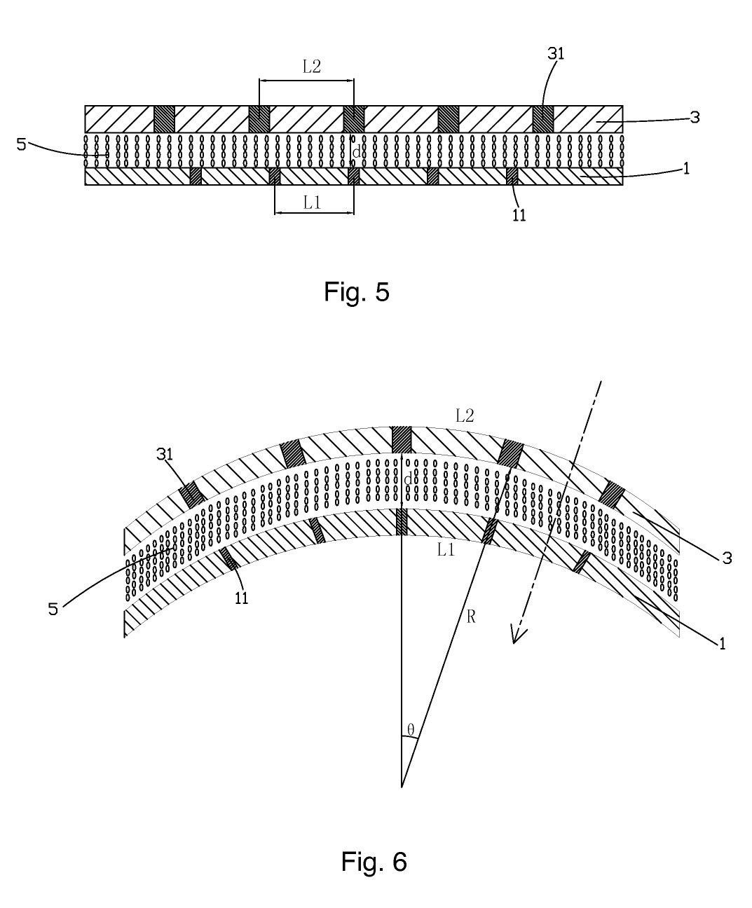

Please refer from FIG. 5 to FIG. 6, which show a second embodiment of a curved liquid crystal panel in curved state according to the present invention. In the second embodiment, the curved liquid crystal panel is an externally bended type, in which the curved liquid crystal panel bended toward the TFT substrate 1.

For realizing that the black matrix 31 radially coincides all data lines 11 along the curved direction, an arc length L1 between two adjacent data lines 11, i.e. the gap L1 between two adjacent data lines in flat state and the gap L2 of the black matrix 31 corresponding to the curved direction, i.e. the gap L2 of the black matrix 31 in the aligned direction of data lines 11 in flat state are required to satisfy the following conditions:

L1=θ×(R−d) (4)

L2=θ×R (5)

wherein θ is a radian corresponding to L1 and L2.

with combination of formula (4), formula (5), which can be derived:

L1:L2=(R−d):R (6)

Accordingly, the gap L1 between two adjacent data lines 11 and the gap L2 of the black matrix 31 in the aligned direction of data lines 11 are unequal, and a proportional relation exists between the L1 and the L2:L1:L2=(R−d):R.

Significantly, when the curved liquid crystal panel is in curved state and the pixel areas of the TFT substrate 1 and the CF substrate 3 are matched, the open area and the shielding area of the curved liquid crystal panel are perpendicularly opposite. Accordingly, defects of the color cast, crosstalk and etc. due to the misalignment of the TFT substrate 1 and the CF substrate 3 can be prevented. The shielding area comprises the black matrix 31 on the CF substrate 3 and wiring location of the data lines 11 on the TFT substrate 1.

In conclusion, according to the curved liquid crystal panel of the present invention, the gap L1 between two adjacent data lines and the gap L2 of the black matrix in an aligned direction of data lines are set to have the proportional relation in flat state to prevent misalignment of the black matrix and the data lines in curved state. Accordingly, the defects of light leakage, crosstalk and etc. can be prevented to promote display and optical qualities of the curved liquid crystal panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A curved liquid crystal panel, comprising: a TFT substrate, a CF substrate oppositely positioned to the TFT substrate and a liquid crystal layer located between the TFT substrate and the CF substrate, and the TFT substrate comprises a plurality of data lines, and the plurality of data lines is equidistantly aligned, and the CF substrate comprises an arrayed black matrix, and a predetermined bending radius of the CF substrate is R, and a cell thickness of the liquid crystal layer is d, in flat state, a gap L1 between two adjacent data lines and a gap L2 of the black matrix in an aligned direction of data lines are unequal, and a proportional relation exists between the L1 and the L2; in curved state, the black matrix radially coincides all data lines along a curved direction to make the pixel areas of the TFT substrate and the CF substrate matched.

2. The curved liquid crystal panel according to claim 1, wherein the predetermined bending radius R of the CF substrate is a distance from a center of the CF substrate in curved state to a surface of the CF substrate close to the liquid crystal layer.

3. The curved liquid crystal panel according to claim 1, wherein the curved liquid crystal panel is bended toward the CF substrate.

4. The curved liquid crystal panel according to claim 3, wherein the proportional relation of the L1 and the L2 is L1:L2=(R+d):R.

5. The curved liquid crystal panel according to claim 1, wherein the curved liquid crystal panel is bended toward the TFT substrate.

6. The curved liquid crystal panel according to claim 5, wherein the proportional relation of the L1 and the L2 is L1:L2=(R−d):R.

7. The curved liquid crystal panel according to claim 1, wherein in curved state, the pixel areas of the TFT substrate and the CF substrate are matched and open area and shielding area of the curved liquid crystal panel are perpendicularly opposite.

8. The curved liquid crystal panel according to claim 7, wherein the shielding area comprises the black matrix on the CF substrate and wiring location of the data lines on the TFT substrate.

9. A curved liquid crystal panel, comprising: a TFT substrate, a CF substrate oppositely positioned to the TFT substrate and a liquid crystal layer located between the TFT substrate and the CF substrate, and the TFT substrate comprises a plurality of data lines, and the plurality of data lines is equidistantly aligned, and the CF substrate comprises an arrayed black matrix, and a predetermined bending radius of the CF substrate is R, and a cell thickness of the liquid crystal layer is d, in flat state, a gap L1 between two adjacent data lines and a gap L2 of the black matrix in an aligned direction of data lines are unequal, and a proportional relation exists between the L1 and the L2; in curved state, the black matrix radially coincides all data lines along a curved direction to make the pixel areas of the TFT substrate and the CF substrate matched;
wherein the predetermined bending radius R of the CF substrate is a distance from a center of the CF substrate in curved state to a surface of the CF substrate close to the liquid crystal layer;
wherein the curved liquid crystal panel is bended toward the CF substrate;
wherein the proportional relation of the L1 and the L2 is L1:L2=(R+d):R;
wherein in curved state, the pixel areas of the TFT substrate and the CF substrate are matched and open area and shielding area of the curved liquid crystal panel are perpendicularly opposite;
the shielding area comprises the black matrix on the CF substrate and wiring location of the data lines on the TFT substrate.
